(19) United States
(12) Patent Application Publication
(10) Pub. No.: US 2006/0028328 A1
(43) Pub. Date: Feb. 9, 2006

(54) Active anti-tailgating and collision warning system

(76) Inventor: William M. Cresse, Mountain Home, ID (US)

Correspondence Address: PEDERSEN & COMPANY, PLLC, P.O. BOX 2666, BOISE, ID, 83701, US

(21) Appl. No.: 10/911,291

(22) Filed: Aug. 3, 2004

(51) Int. Cl. B60Q 1/00; E05F 15/00; G01S 13/00; G08B 21/00

(52) U.S. Cl. 340/435; 340/686.6; 701/45; 342/72

(57) ABSTRACT

The present invention is a system for use, for example, in motorized vehicles to provide a warning signal directed to the attention of the driver of the equipped vehicle and also to the operator of a target vehicle, as well as possibly other drivers in the vicinity of the system-equipped vehicle of impending danger. The system senses the presence of obstacles that can be identified by scanning and subsequently tracked. Obstacles may be fixed objects or other vehicles either also moving or still. The system detects and determines the distance separating the object from the sensor location, its ground velocity and rate of closure. The system's signaling sound and light emitters are able to be positioned and adjustable to face a target receiver and are able to signal with varying sound and light patterns and output amplitudes.

### BACKGROUND OF THE INVENTION

1. Field of the Invention

The present invention relates generally to vehicle collision detection and warning devices and more specifically to electronic devices that detect the presence of objects and/or vehicles, determine range and speed of closure, and produce alarm indications.

2. Description of Related Art

A variety of anti-tailgating and collision warning systems are known in the prior art. For instance, U.S. Pat. No. 3,949,362 issued to Doyle, et al. discloses a signal beam being operable to actuate a signal detector. The methods and apparatus of this invention function only on vehicles traveling in tandem. It performs speed detection by sensing only visible light. Unlike the present invention, it is a passive, not active, device. Also, there are no scanning, targeting, nor tracking capabilities.

The invention disclosed in U.S. Pat. No. 4,600,913 to Caine discloses a lamp housing with a lens that changes opacity as trailing vehicle nears. This approach is different from the present invention in that it is based upon an lamp with a lens that has a plurality of opaque lines of varying widths in such a way as to alarm the driver of a trailing vehicle as he/she approaches the device mounted on the leading vehicle.

U.S. Pat. No. 4,833,469 to David and U.S. Pat. No. 6,240,346 to Pignato disclose response to the presence of obstacles located ahead of a vehicle, not behind a vehicle. They are each different from the present invention in that they represent passive devices. The invention of David is specific to probing with an electromagnetic radiation beam and is concerned with object detection only. The invention of Pignato mainly involves calculation of potential collision speed and collision angle. While it provides a signaling light, it does not aggressively signal its target. Neither invention involves object targeting or tracking.

U.S. Pat. No. 6,534,884 to Marcus, et al. discloses apparatus that, while active in that a light signaling device is incorporated, is more suited to use between two vehicles and for warning tailgaters. It has no apparatus for scanning, targeting, or tracking. While is it able to provide fluid, proportional control of a light bank, it does not provide for fluid control of speed, frequency, brightness, closure, intensity or distance.

U.S. Pat. No. 6,263,282 to Vallancourt discloses a system that captures signals from a vehicle and conveys the signals to a decision circuit, which determines whether a dangerous driving condition exists and outputs an activation signal upon detecting a dangerous condition. This invention does not mention sensing methods or technologies.

After reviewing prior art searches and commercially available detection and signaling products, it is believed that none of the documents or devices in the prior art disclose a detection and signaling device having the combination of features and the distinct advantages of the present invention.

### SUMMARY OF THE INVENTION

Therefore it is an object of the present invention to provide an anti-tailgating and collision warning system incorporating particular aspects that provide a higher level of safety, enhance its practicality and usefulness, and bring generally greater benefit to its users than can be realized through similar, but different, means.

The present invention is intended for mounting on a vehicle or on a fixed point, such as in a work area or near an obstruction. Preferably, incorporated into a main housing of the device are the electronic components that perform power regulation, communication, system control, motors, sensors, sound emitters and light emitters.

The housing serves to securely fix and retain these components and to protect them from moisture and dirt. Preferably, motors provide position control of the housing in the vertical axis, or in both horizontal and vertical axes, making it able to swivel and/or tilt on its mounting, thereby allowing sensors and signaling equipment to be oriented to face in different directions under on-board or external control.

The methods by which multiple, co-directed or independently directed sensors scan the detection area surrounding the device, and the method by which the data are evaluated through algorithmic computation to determine existence and location of a target are important aspects of the present invention. If objects are detected, sequences of lights and/or alarm sounds are used to alert the operators of the vehicles involved. The multiple object detector elements of the present invention provide target position and tracking information, which in turn allows control of servo-positioners to aim the sound and light emitters at target receivers. Once an object is detected, it's range, speed and rate of closure can be ascertained through computation of incoming data. Subsequently, the operator of the equipped vehicle can be alerted, and sound and light patterns and output amplitudes of the external signaling emitters can be varied by proportional “fluid” control, thereby providing the ability to signal varying levels of alarm. Also, the external signaling emitters can be adjusted in direction, thereby providing the ability to “aim” output alarm signals.

In summary, what sets the present invention apart from other similar inventions and commercially available products is the incorporation of the following beneficial aspects:
a) Signals the operator of the sensing vehicle, the operator of a target vehicle, as well as any other nearby vehicles that an alarm condition exists,
b) Actively scans, targets and tracks objects within its detection zone or perimeter.
c) Actively signals with varying amplitudes and patterns of light and sound alarms.
d) Actively positions its signaling emitters toward the target receiver.
e) Provides fluid adjustment of speed, frequency, brightness, number of pulses and color, which, for example, can be set based upon proximity and rate of closure.

As will be put forth in the following detailed description, accompanying drawings and claims, the present invention provides a practical and useful way of sensing danger and alerting operators and drivers that realizes a high benefit of safety and accident prevention.

### BRIEF DESCRIPTION OF THE DRAWINGS

FIG. 1A-D is a set of orthographic views and an isometric view of the housing of one embodiment of the present invention.

FIG. 2 is a schematic block diagram of one embodiment of the present invention.

FIG. 3 is a schematic block diagram of an alternate embodiment of the present invention.

FIG. 4 depicts one possible mounting configuration of one embodiment of the present invention.

### DETAILED DESCRIPTION OF THE INVENTION

The present invention provides safety, through collision prevention, for trucks and automobiles on all road systems, as well as safety for aircraft, trains and watercraft. Beyond roadways, this invention can help prevent collisions between vehicles and other vehicles and/or objects at locations such as shipping docks, parking lots, airports, equipment yards, and other busy locations. By using acoustic energy and light energy to signal equipment operators and vehicle drivers, they can have an early warning of potential danger. Sensors, sensing electronics and sensing algorithms provide information such as offending object locations and tracking servo control information, allowing the sound and light energy emission to be directed by actuators and warning levels to be increased, as needed. Using such active sensing techniques and providing directed, high-impact alerts to drivers of offending vehicles and possibly to other drivers in the vicinity of the danger provides a high human benefit in that advance warnings, made possible by the devices and algorithms that comprise the present invention, bring improved reaction times that help to avert collisions.

One aspect of the present invention is its directionality. Either the fully contained assembly or individual sensing and alarm modules may be aimed in one or more axes by servo control and motor actuation via a rotating mounting shaft, for example. In one embodiment of the invention, closed loop control is achieved by sensing actuator position and implementing a control algorithm that determines actuation required to move to a desired position. This type of algorithm is commonly known in the art, and can be run as a task on the operating kernel of the microcontroller within the present invention.

Commands to position the servo can also come from either the internal automatic scanning and tracking algorithms, or can come from an external interface, whereby external controllers and operators can position sensor and emitter equipment, as required for the numerous applications that are possible for the invention. The motor(s) that control the sensor/emitter directionality can position either an internal subassembly or position the entire outer housing. In the preferred embodiment, the entire outer housing of the fully contained invention moves as it scans/tracks in a single, horizontal axis degrees +/−45 degrees. This preferred embodiment mounts into a recess in a vehicle or in a fixed location.

Another aspect is that the present invention's scanning and tracking modes can be automated or programmable. A user can set scan speed, brightness and loudness levels, for example, via the external interface. Alarm types in the preferred embodiment are arranged in levels for both light emitters and audible alarm emitters, depending upon vehicle closing speed, etc., with patterns of flash/beep varying from solid on, to single, to multiple flashes/beeps at different rates. For example, a repeating four flash/beep sequence signifies a level of high notification.

The componentry of the invention can alternately be either fully contained within a plastic housing that is flush mounted within the body of a vehicle or on a fixed point, or the mountable component parts may be distributed in modular subassemblies. For example, there may be a module or modules for audible and/or light alarms, a module or modules for detection sensors, and a module or modules containing power supplies and/or control electronics. Embodiments of the present invention can incorporate an optional magnetic mount or pipe-mounted scheme, allowing installation onto vehicles or in fixed locations in a wide variety of ways.

These and other embodiments of the present invention will now be described by way of example, with reference to the accompanying drawings:

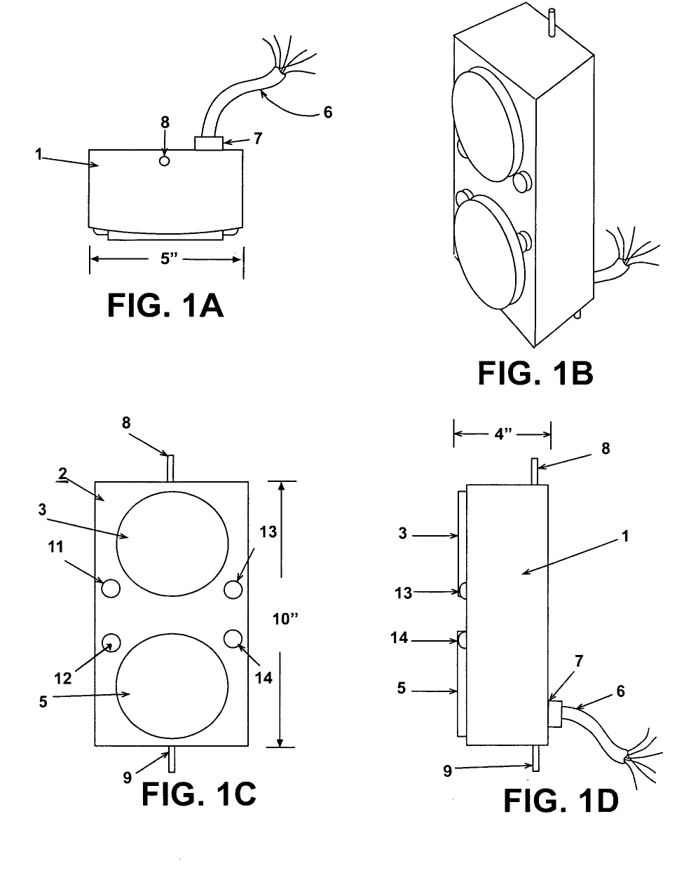

FIG. 1 is a set of orthographic views and an isometric view of the exterior of one embodiment of the present invention. Outer case 1 can be made of a suitable environmentally tough material, such as Lexan, ABS or powder coated aluminum. It encloses an electronics circuit assembly (not depicted) that performs all necessary internal electronic functions of the invention, as detailed herein. The present invention is operated using solid-state electronics, which sense input sensors and intelligently control output circuits. The primary electronics assembly can be conformally coated with a coating material such as 3M Novec EGC-1700.

Preferably, plastic case 1 pivots on upper and lower rotating pivot rods 8 and 9. Not shown are the different mounting flanges and fixturing approaches that can be employed to facilitate connection of pivot rods 8 and 9 to a vehicle or fixed object. Feed-through strain relief 7 secures power and signal cable 6 at its point of exit from case 1. Connection is accomplished in a preferred embodiment of the present invention via wire connection studs (not depicted) to three or four 18 AWG wires: V+, one or two Signal leads and Ground, but other connection schemes may be used in an equivalent manner.

Front panel 2 is the primary mounting surface for the various sensors and emitters. Light emitter 3 and audio emitter 5 provide the ability to signal a state of alarm or emergency to operators of vehicles that are approaching the invention. Also incorporated into front panel 2 are the different sensors: acoustic range-finding and speed detection sensor 11, laser range-finding and speed detection sensor 12, magnetic hall-effect proximity sensor 13 and infrared proximity sensor 14. By using these sensors in combination, each having different sensing capabilities, it possible to accurately detect an object's speed, its distance from the sensor surface, and its rate of closure.

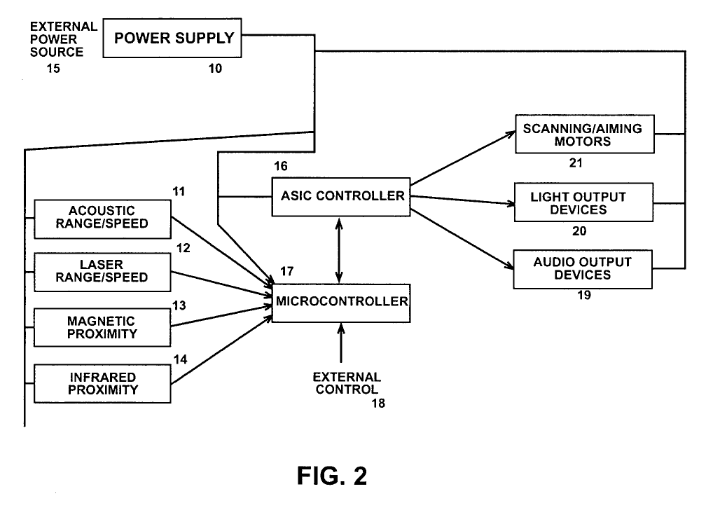

FIG. 2 is a schematic block diagram of one embodiment of the present invention. It features both a programmed microcontroller 17 and an Application Specific IC (ASIC) controller 16 that work in concert to analyze sensor data and to provide appropriate emitter output signals to scanning and aiming motors 21, light output devices 20 and audio output devices 19. Microcontroller 17 also features an external interface, by which data may be exchanged with various host devices. Under programmatic control, signal processing can be performed by reading real-time data streams from sensors 11 through 14 into microcontroller 17, storing the data into RAM into ring-type buffers, with buffer sizes that are scaleable as needed by the signal processing algorithms. When data processing reveals the presence of an object or objects within range of one or more of the sensors 11 through 14, the ASIC controller 16 can be provided with object position and alarm signal status by microcontroller 17. The ASIC controller 16 can then emit alarm signals and position the scanning and aiming motors 21. Frequent updates regarding an object's position can be taken by microcontroller 17, and frequent positioning data updates can then be provided to ASIC controller 16, whereby the position of the device of the invention can be adjusted to scan for objects and to track a located object's movement.

With regard to the control of the light output devices 20 and audio output devices 19, the invention is capable of adjusting, for example, light brightness, flash rate and flash duration. As regards the audio output devices 19, the audible level of the alarming horn of the preferred embodiment is variable from, for example, 0 to +117 dBA, with its audio level being proportional to a computed control variable. Audible output devices can alternately consist of speakers, piezo-resonators or various types of horns.

Light output devices 20 can alternately be comprised of different combinations of LED or other solid-state emitters, Xenon strobe lamps, halogen bulb rotator assemblies or other types of incandescent lights. In one embodiment, a self-contained light emitter device can be used, such as an American Superlite SL 4000, which is a multi-element LED emitter assembly. A control capability is provided whereby a light level of, for example, 0 to 100,000 candela (cd) is obtained from a light device over the span of an adjustment, proportional to a computed control variable. For impulse type light emitters, energy level can be variable from, for example, 0 to 21 Joules when using a typical stroboscopic lamp, proportional to a computed control variable.

With regard to external lamp features, lens optics can be incorporated into different embodiments for desired light dispersal characteristics and environmental protection. Fresnel, modified Fresnel, multi-lensed assemblies and/or color-tinted lenses may also be incorporated. One or more separate light emitter modules may be employed on different areas of a vehicle or at a fixed location to increase visibility.

To power the circuitry of the present invention, external power source 15 provides AC or DC power from a vehicular power source or from a fixed location power source to power supply 10, which in-turn provides filtered and regulated power via separate, multiple outputs as necessary to operate all circuitry that is comprised with the present invention. In one embodiment, the circuit accepts an input voltage of from 12 to 48 VDC, while alternate embodiments may accept 110 to 270 VAC, or other voltages as required. The preferred embodiment has an average input current requirement of less than one Ampere. Voltage spike protection of the preferred embodiment circuitry of +100/−400 volts is provided, as well as reverse-polarity protection.

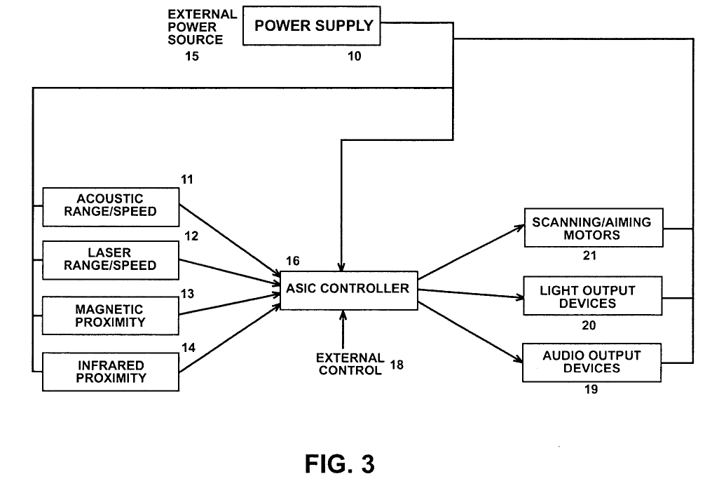

FIG. 3 is a schematic block diagram of an alternate embodiment of the present invention. It differs from the embodiment depicted in FIG. 2 in that it does not include a separate microcontroller, but instead uses only an ASIC controller 16 to perform all sensing and control functions. ASIC controller 16 provides capability to perform a scan for objects and to track any located objects' movements by driving the scanning and aiming motors 21.

Today's ASIC technology, such as is available from Xilinx or Atmel Semiconductor, incorporates advanced microcontroller core logic that executes machine instructions from internal program memory. In utilizing such core functionality, all programmable machine states, features and algorithms that can be performed in the embodiment of FIG. 2 can be similarly implemented on the embodiment of FIG. 3.

With regard to the methods for controlling the output functions of positioning, light and sound, there are numerous and myriad possible control algorithms that can be performed by the logic circuits of the present invention. This is true whether these algorithms are embedded via ASIC, field programmable gate array (FPGA), or microcontroller based logic. These control algorithms decide their actions based upon deterministic processing of input stimuli from the sensor elements of the present invention. The following is an exemplary set of criteria and resultant behaviors:

Motor Control:
1. A continually looping control algorithm is typically implemented in the preferred embodiment such that a scanning motion of the directional element of the invention is output to the positioning motor(s). Best practice scanning patterns ranging from simple left to right, right to left, etc., to more complex Lissajous curves can be implemented. One of multiple possible modes for scanning can be activated by user selection.
2. Scanning speeds can be variable based upon input from range and speed sensors, or pre-determined speeds can be established.
3. If a target is detected and tracking is warranted, algorithms output aiming commands to motors (perhaps via polar coordinates).
4. If a target is detected by short-range sensors, or is a warm body, or has a high closure speed, then targeting and tracking is warranted.

Light Source Control:
1. A continually looping control algorithm is typically implemented in the preferred embodiment, such that light devices of the invention are highly controllable.
2. Combinations of light colors and light intensities are controllable via embedded logic and/or software. For stroboscopic lamps, various flash patterns, flash sequences, flash frequencies and flash energies are possible.
3. If a target is detected by short range sensors, such as the nearby presence of a warm human or animal body via infrared sensor, or if an object has high closure speed, then the light color can be set to red, the flash frequency set to maximum, and flash energy set to maximum.
4. If a target is detected by medium range sensors, or other discretionary mode settings are in effect, then the light color can be set to amber, flash frequency and flash energy can be set to less than maximum.
5. Similar reductions in alarm states can occur for targets detected by long-range sensors.

Sound Source Control:
1. Many different sound pressure levels, sound frequencies, horn or annunciator beep sequences and beep durations are possible.
2. If a target is detected by short-range sensors, such as the nearby presence of a warm human or animal body via infrared sensor, or if an object has high closure speed, then sound pressure levels can be maximized, and beep durations can be maximized.
3. If a target is detected by medium range sensors, or other discretionary mode settings are in effect, then sound pressure levels can be set to less than maximum, and beep durations of horn or annunciator-type sound emitters can be set to less than maximum.
4. Similar reductions in alarm states occur for targets detected by long-range sensors.

As regards the availability of sensors from commercial sources, ultrasonic sensors are typically medium-range. Standard detection distances of 18′ or better are possible. For example, Honeywell offers a Series 946 ultrasonic sensor. Alternatively, ultrasonic sensors typically used for automobile reversing aides from Mitsubishi Electric are suitable.

Laser sensing technology is applicable for long-range sensing, with standard detection distances available to 640 m. For example, Keyence's LV Series Long Distance Digital Laser Optic Sensor can be applied.

Object proximity sensors are typically short-range devices. These include inductive proximity sensors and photoelectric sensors. Keyence's ES Series Proximity Sensor and/or Keyence's PS Series Photoelectric Sensor are suitable for application in the present invention.

Infrared sensors have standard detection distances ranging from approximately one to 30 meters. Specific examples of potential infrared sensors can be found at www.hobbyengineering.com, or http://www.interq.or.jp/japan/se-inoue/e_pyro.htm. Suppliers of infrared sensors include Omron, Keyence, Honeywell, Hobby Engineering and Banner Engineering Corporation.

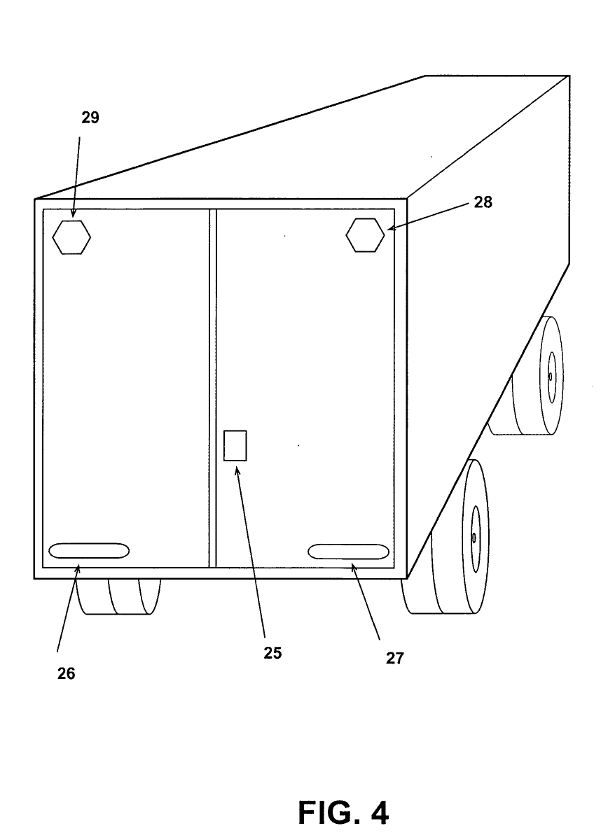

FIG. 4 depicts one possible mounting configuration of one embodiment of the present invention. In this figure, the rear of a truck trailer is shown, in which five modules are installed into embedded wells or openings in the rear doors. Sensor array module 25 is located in the center of the door area and contains the sensing electronics of the present invention, while light emitting modules 26, 27 are mounted in the lower left and lower right corners. Sound emitting modules 28, 29 are located in the upper right and left corners, respectively.

It should be noted that there might be different configurations than are shown using a similar, modular approach depicted in FIG. 4. Sensing and emitting elements may also be mounted on the sides of a vehicle, in differing numbers and arrangements with respect to one another. The wiring between modules may be accomplished via built-in wiring looms in the trailer frame, or modules may be wired together through a separate wiring harness.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

I claim:

1. A movable sensor adapted to identify and track an object which is moving relative to the sensor;
said sensor having an adjustable output which is directed at said relatively moving object.

2. The invention of claim 1 comprising a plurality of movable sensors.

3. The invention of claim 1 comprising a plurality of adjustable outputs.

4. The invention of claim 1 wherein the movable sensor is on a vehicle.

5. The invention of claim 1 wherein the adjustable output is on a vehicle.

6. The invention of claim 1 wherein the adjustable output is audible.

7. The invention of claim 1 wherein the adjustable output is visible.

8. The invention of claim 1 wherein the adjustable output is adjustable in magnitude.

9. The invention of claim 1 wherein the adjustable output is adjustable in direction.
